(19) United States
(12) Patent Application Publication
(10) Pub. No.: US 2004/0081735 A1
(43) Pub. Date: Apr. 29, 2004

(54) Encapsulated flavor and/or fragrance preparations

(76) Inventors: Birgit Schleifenbaum, Hoxter (DE); Jens Uhlemann, Holzminden (DE); Reinhard Boeck, Kaarst (DE); Jurgen Hinderer, Dormagen (DE)

Correspondence Address: Stephan A. Pendorf, Pendorf & Cutliff, 5111 Memorial Highway, Tampa, FL, 33634-7356, US

(21) Appl. No.: 10/602,409

(22) Filed: Jun. 23, 2003

Related U.S. Application Data
(63) Continuation of application No. 09/868,297, filed on Jun. 15, 2001, now abandoned.
Application No. 09/868,297 is a 371 of international application No. PCT/EP99/09644, filed on Dec. 18, 1998.

(30) Foreign Application Priority Data
Dec. 18, 1998 (DE) 198 58 729.5
Nov. 25, 1999 (DE) 199 56 604.6

(51) Int. Cl. A23L 1/236

(52) U.S. Cl. 426/548

(57) ABSTRACT

This invention relates to encapsulated flavor and/or fragrance preparations and a method for producing same from a spray solution consisting of an aqueous solution of polymeric carriers and emulsified flavors and/or fragrances. The granules have an adjustable particle size of between 0.2 and 2 mm, present even size distribution and a globular shape and are further characterized by a high concentration and high retention of volatile flavors.

The present invention relates to flavouring preparations and/or perfume preparations encapsulated by continuous fluidized-bed spray agglomeration, a process for their production and their use, preferably in food.

Flavourings and perfumes are complex liquid mixtures generally of liquid components. Flavouring granules are required for different purposes. Flavouring encapsulation via spray-drying is customary, but in this only relatively fine and irregularly structured particles are produced (R. Büttiker, Dissertation ETH Zürich No. 6148).

An alternative to spray-drying is producing flavouring granules via fluidized-bed spray agglomeration. EP A 070 719 describes, for example, the production of flavouring granules in a conventional batch-operated fluidized bed. An emulsion of the flavourings to be granulated is sprayed into a fluidized bed which consists of air-fluidized particles. The particles then act as nuclei for the formation of the granule grains.

WO 97/16078 describes the production of flavouring granules in a conventional batch-operated fluidized-bed rotor granulator. The rotor granulator generates a vortexing of the fluidized bed present therein by means of a rotating base plate. In this process material can only be sprayed onto previously introduced cores, so that the flavouring content of the final product is very low.

Both processes operate batchwise, that is to say after processing a spray-solution batch, the production process is terminated and the granules are taken out of the apparatus. A new spray solution batch must then be processed. For reasons of economic efficiency, the processes must therefore be operated with high bed contents. For preset granule growth, a corresponding amount of spray solution must be evaporated. Therefore the high bed contents lead to long residence times of the granules which are in the range of hours. However, the long residence time with simultaneous heat stress of the granules in an air steam leads to correspondingly high losses in the volatile flavourings. Reducing air temperature and/or air throughput does not decrease the flavouring loss, since then, inevitably, the time for evaporating the spray solution is extended.

A further disadvantage of the process according to EP A 070 719 is that the products it produces must be rescreened to produce narrow particle size distributions. Firstly this is an additional labour cost, secondly valuable material is lost in the course of this.

A disadvantage in WO 97/16078 is the high proportion of filler in the granule core (approximately 60 to 90% by weight) and the adsorption of the flavourings to the granules which is only at the surface. The surface adsorption reduces the protection of the flavourings, limits the maximum loading and leads to undesirably high contents of flavourings of the surface of the granules.

Although the granules produced according to EP A 070 719 or WO 97/16078 can be provided with a coating in order to adjust the solubility and flavouring-release behaviour, or to achieve a specific protective action, the still relatively non-uniform particle size distribution and the relatively irregular granule surface make uniform coating with constant coating thickness difficult. An actually time- or temperature-controlled release of the flavourings or perfumes can thus not be achieved.

The purpose of the present invention is granulated encapsulated flavouring preparations and/or perfume preparations. The granules should have a settable particle size, preferably in the range from 0.2 to 2 mm, with a narrow particle size distribution and spherical geometry, and have a high loading with volatile flavourings. During production the retention of the volatile flavourings is to be able to be maximized, the screening losses are to be able to be minimized and the yield of a settable desired particle size is to be able to be maximized. The granules should, in addition, provide the ideal preconditions for coating, so that by proper choice of coating the flavouring properties can be specifically matched to an application.

Encapsulated flavouring preparations and/or perfume preparations have been found which are produced by means of continuous fluidized-bed spray agglomeration in which a flavouring preparation and/or perfume preparation is sprayed into a fluidized bed containing agglomeration nuclei and in which the mean residence time of the flavouring preparation and/or perfume preparation sprayed in is less than 20 minutes in the fluidized bed.

The inventive novel flavouring preparations and/or perfume preparations fulfil the abovementioned requirements. In particular they have particle sizes of 0.2 to 2 mm, they are dust-free, the flavouring loadings are in the range from 1 to 25% by weight, the retentions of the flavourings during the agglomeration process are in the range of 60 to 90% by weight.

A process has also been found for producing encapsulated flavouring preparations and/or perfume preparations, produced by fluidized-bed spray-agglomeration, in which a flavouring preparation and/or perfume preparation is sprayed into a fluidized bed having agglomeration nuclei, characterized in that the mean residence time of the flavouring preparation and/or perfume preparation sprayed in is less than 20 minutes in the fluidized bed.

The mean residence time of the flavouring preparation and/or perfume preparation sprayed in is preferably 2 to 15 minutes, in particular 5 to 10 minutes, in the fluidized bed.

In studies it has been found that, firstly, flavourings and/or perfumes can be sufficiently granulated in a short time span of this type, and that, secondly, a product is obtained that is considerably improved with respect to the distribution of particle sizes, the geometry, the retention and loading. A high loading here means a high total amount of encapsulated flavouring based on the granule mass. The higher the retention of the individual volatile components, the lower are the losses of these components.

The inventive process can be carried out batchwise and continuously. Preferably, the inventive process is carried out continuously. A continuous process is more suitable for industrial production and has short residence times. At the same material throughput, the bed contents in the continuous processes of fluidized-bed spray agglomeration are lower than in the batchwise process. Instead of the total amount of all granule nuclei being made to grow simultaneously, in the continuous fluidized bed spray agglomeration, only a small amount of the granule nuclei are sprayed and after reaching the desired granule size they are immediately discharged via a sifter. The inventively produced encapsulated flavouring and/or perfume preparations have a small particle size distribution; in addition, the grains of the appropriate size can be specifically taken off.

In the context of the present invention, it is preferred, therefore, that the fluidized bed has a small bed height. Preferably this is 3 to 50 cm, in particular preferably 5 to 20 cm.

Continuous fluidized-bed spray agglomeration produces, from a spray solution consisting of water, emulsified flavouring and dissolved/suspended carriers, free-flowing, low-dust, grainy granules having encapsulated flavouring/perfume. In the ideal case, the basic operations of nucleus generation, drying, shaping and selective discharge of the granules which have achieved the desired particle size are performed simultaneously in one apparatus.

The fundamental principle of continuous fluidized-bed spray agglomeration (Chemie-Ingenieur-Technik, Vol. 62. (1990), pages 822 to 834) has been implemented in numerous variants. A distinction must be made, in particular, between the variants having external nucleus formation, in which nuclei are added to the bed from external sifters, grinders or other solids reservoirs, and variants having internal nucleus formation. In a comparison, the variants having external nucleus formation always have an increased residence time for two reasons:

1. The bed height is controlled via the nucleus supply and can therefore not be reduced below a controllable minimum.

2. External solids circuits are required for the process.

In the context of the present invention, therefore, processes having internal nucleus supply are preferred. One such process is, for example, the process described in EP A 163 836. This, in addition, is provided with a self-controlling mechanism for particle size control and therefore has a minimum residence time.

The spray solution can be sprayed into the fluidized bed from the bottom, from the side, but also from the top. For removing entrained solids from the exhaust air, numerous variants are possible which differ by the separation method (for example cyclone or filter) or by the position of removal (inside or outside the granulator).

Finally, for discharging the granules, preferably sifters are used. Using sifters means that only the coarse particles can leave the fluidized bed. The remaining particles remain behind in the fluidized bed until they also have achieved the desired particle size.

The granule particles are preferably, after their production, provided with a coating. This coating can be applied either in fluidized-bed apparatuses suitable therefor (top-spray coaters, bottom-spray coaters, Wurster coaters) or in film coaters. This is achieved by spraying on a solution, emulsion, dispersion or melt of a substance, which is known to be used for these purposes owing to its film-forming properties. Coating materials which can be used are substances or mixtures of substances, for example fats, waxes, proteins such as gelatin, hydrocolloids such as starches, degraded starches, chemically modified starches, modified celluloses, microcrystalline cellulose, plant exudates, such as gum arabic, ghatti gum, tragacanth, gum karaya, plant extracts such as carrageenan, guar seed meal, carob bean flour, agar, alginates, pectin, inulin, animal extracts such as chitosan and schellac, products of microorganisms such as xanthan gum, gellan gum, plastics which can be used in cosmetics or pharmaceuticals, for example polyvinylpyrrolidone, polyacrylate, polymethacrylates, polyvinylacetate phthalate, polyethylene glycol. The coating material is matched to the respective requirements of the granules, depending on the application.

The spray solution to be granulated can, similarly to the procedure in spray-drying of flavourings, consist of water having dissolved and/or suspended polymeric carriers and emulsified flavouring. The polymeric carriers can be hydrolysed or modified starches or hydrocolloids, for example gum arabic, as pure substances or in any mixing ratios.

Customary additives and ingredients such as food or cosmetic colourings, sweeteners, antioxidants, edible acids such as citric acid, flavour-enhancing substances such as sodium glutamate, vitamins, minerals, juice concentrates etc. can be added to the spray solution to be granulated.

The inventive process of fluidized-bed spray agglomeration is preferably carried out at elevated air temperatures in the range from 60° C. to 180° C., preferably from 100° C. to 140° C. The air throughput is chosen to be as great as possible for maximum drying performance. The suitable gas velocities are in the range from 0.5 to 1.5 m/s, preferably 1 m/s. The permissible product temperature is linked to the exhaust air temperature and is set via the spraying rate of the spray solution. The bed height in the procedure according to EP A 163 836 is only a few centimetres. The bed height in the variant having external nucleus formation is controlled in the range from 20 to 50 centimetres.

Suitable flavourings and perfumes are complex flavouring compositions which can comprise all individual components previously used for flavourings and perfume, that is to say flavouring and/or perfumes and essential oils or fractions thereof, but also individual flavourings or perfumes, for example acetaldehyde, menthol, ethyl butyrate, etc., or essential oils or fractions thereof.

Flavourings and perfumes which may be mentioned by way of example in the context of the present invention are preferably: berries, citrus, pome fruit, cheese, meat, fish, seafood, spices, herbs, vegetables, coffee, chocolate, mint, tobacco, wood, flowers, etc.

The inventive encapsulated flavouring preparations and/or perfume preparations can preferably be used in foods.

The invention will be described below with reference to examples.

### Production Examples

### EXAMPLE 1

### Strawberry

In an agglomeration apparatus of the type described in EP 163 836 (having the following features: diameter of gas distributor plate: 225 mm, spray nozzle: two-component nozzle; classifying discharge: zig-zag sifter; filter: internal bag filter) a solution consisting of 44% by weight of water, 11% by weight of strawberry flavouring, 13% by weight of gum arabic and 32% by weight of hydrolysed starch (maltodextrin DE 15-19) is agglomerated. The solution is sprayed into the fluidized-bed agglomerator at a temperature of 32° C. To fluidize the bed contents, nitrogen is blown in at a rate of 140 kg/h. The inlet temperature of the fluidizing gas is 140° C. The temperature of the exhaust gas is 76° C. As classifying gas, nitrogen is also fed at a rate of 15 kg/h at a temperature of 50° C. The fluidized bed contents are approximately 1 700 g. The agglomeration output is approximately 2.8 kg per hour. Free-flowing granules having a mean particle diameter of 1 mm at a bulk density of 600 g/l are obtained. The granules are round and have a smooth surface. Because of the constant pressure drop of the filter and the also constant bed contents, steady-state conditions with respect to the agglomeration process are to be assumed.

### EXAMPLE 2

### Mint

In the apparatus described in the example “strawberry”, agglomeration is carried out of a solution consisting of 37% by weight of water, 15% by weight of gum arabic, 35% by weight of hydrolysed starch (maltodextrin DE 15-19) and 13% by weight of peppermint aroma. The solution is dyed with blue dye (E131) (40 g of a 2% strength solution). The solution is sprayed into the fluidized-bed agglomerator at a temperature of 35° C. To fluidize the bed contents, nitrogen is blown in at a rate of 130 kg/h. The inlet temperature of the fluidizing gas is 140° C. The exhaust gas temperature is 85° C. The classifying gas supplied is also nitrogen at a rate of 16 kg/h at a temperature of 30° C. The contents of the fluidized bed are approximately 1 700 g. The agglomeration output is approximately 4 kg per hour. Free-flowing granules having a mean particle diameter of 1 mm at a bulk density of 550 g/l are obtained. The granules are round and have a rough surface.

In the same apparatus, the previously produced granules were coated with the fat Revel A (from Loders Croklaan); 400 g were introduced in advance as a bed. By increasing the classifying gas rate to 23 kg/hat 25° C., no material is discharged, that is to say coating takes place batchwise. The melt is sprayed into the fluidized-bed agglomerator at a temperature of 74° C. The temperature of the atomizing gas is 70° C. To fluidize the bed contents, nitrogen is blown in at a rate of 100 kg/h. The inlet temperature of the cooled fluidizing gas is 16° C. The exhaust gas temperature is 28° C. Free-flowing granules are obtained. The granules are round. SEM images of the fracture surfaces show a substantially uniform coating of the granules with the fat.

### EXAMPLE 3

### Tea Extract

In the apparatus described in the example “strawberry”, a solution consisting of 25% by weight of water, 4% by weight of gum arabic, 19% by weight of hydrolysed starch (maltodextrin DE 15-19) and 52% by weight of tea extract (solids content approximately 63% by weight) is agglomerated. To fluidize the bed contents, nitrogen is blown in at a rate of 110 kg/h. The inlet temperature of the fluidizing gas is 138° C. The exhaust gas temperature is 80.5° C. The classifying gas supplied is also nitrogen at a rate of 11.5 kg/h at a temperature of 81° C. The contents of the fluidized bed are approximately 450 g. The agglomeration output is approximately 2 kg per hour. Free-flowing granules are obtained having a mean particle diameter of 0.8 mm. The granules are round and have a very smooth surface.

### EXAMPLE 4

### Chicken

In the apparatus described in the example “strawberry”, a solution consisting of 44% by weight of water, 14% by weight of gum arabic, 31% by weight of hydrolysed starch (maltodextrin DE 15-19) and 11% by weight of chicken flavouring is agglomerated. The solution is sprayed into the fluidized-bed agglomerator at a temperature of 30° C. To fluidize the bed contents, nitrogen is blown in at a rate of 130 kg/h. The inlet temperature of the fluidizing gas is 140° C. The exhaust gas temperature is 91° C. The classifying gas supplied is also nitrogen at a rate of 16 kg/h at a temperature of 65° C. The contents of the fluidized bed are approximately 650 g. The agglomeration output is approximately 2 kg per hour. Free-flowing granules are obtained having a mean particle diameter of 1.5 mm. The granules are round and have a moderately smooth surface.

### EXAMPLE 5

### Raspberry

In the apparatus described in the example “strawberry”, a solution consisting of 50% by weight of water, 11% by weight of gum arabic, 22.5% by weight of hydrolysed starch (maltodextrin DE 15-19) and 16.5% by weight of raspberry flavouring and a small amount of colouring is agglomerated. The solution is sprayed into the fluidized-bed agglomerator at a temperature of 32° C. To fluidize the bed contents, nitrogen is blown in at a rate of 110 kg/h. The inlet temperature of the fluidizing gas is 130° C. The exhaust gas temperature is 84° C. The classifying gas supplied is also nitrogen at a rate of 9 kg/h at a temperature of 81° C. The contents of the fluidized bed are approximately 300 g. The agglomeration output is approximately 1.5 kg per hour. Free-flowing granules are obtained having a mean particle diameter of 0.5 mm. The granules are round and have a moderately smooth surface (sometimes with secondary agglomerates).

In the same apparatus, the previously produced granules were coated with boysenberry flavouring (solution consisting of 50% by weight of water, 11% by weight of gum arabic, 22.5% by weight of hydrolysed starch (maltodextrin DE 15-19) and 16.5% by weight of boysenberry flavouring); 530 g are introduced in advance as a bed. By increasing the classifying gas rate to 20 kg/h at 90° C., no material is discharged, that is to say coating takes place batchwise. The solution is sprayed into the fluidized-bed agglomerator at a temperature of 26° C. The temperature of the atomizing gas is 30° C. To fluidize the bed contents, nitrogen is blown in at a rate of 110 kg/h. The inlet temperature of the fluidizing gas is 130° C. The exhaust gas temperature is 82° C. Free-flowing granules are obtained. The solid particles are round. SEM images of the fracture surfaces show a very uniform coating of the granules.

### EXAMPLE 6

### Ethyl Butyrate

In the apparatus described in the example “strawberry”, a solution consisting of 38% by weight of water, 15% by weight of gum arabic, 34% by weight of hydrolysed starch (maltodextrin DE 15-19) and 13% by weight of ethyl butyrate is agglomerated. The solution is sprayed into the fluidized-bed agglomerator at a temperature of 38° C. To fluidize the bed contents, nitrogen is blown in at a rate of 125 kg/h. The inlet temperature of the fluidizing gas is 105° C. The exhaust gas temperature is 66° C. The classifying gas supplied is also nitrogen at a rate of 10 kg/h at a temperature of 30° C. The contents of the fluidized bed are approximately 1 650 g. The agglomeration output is approximately 1.4 kg per hour. Free-flowing granules are obtained having a mean particle diameter of 0.5 mm at a bulk density of 465 g/l. The granules are round and have a moderately smooth surface.

### EXAMPLE 7

### Model Flavouring Mixture

In the apparatus described in the example “strawberry”, a solution consisting of 50% by weight of water, 4% by weight of gum arabic, 36% by weight of hydrolysed starch (maltodextrin DE 15-19) and 10.0% by weight of model flavouring mixture (limonene: ethyl butyrate: phenylethanol=1:1:1) is agglomerated. The solution is sprayed into the fluidized-bed agglomerator at a temperature of 22° C. To fluidize the bed contents, nitrogen is blown in at a rate of 125 kg/h. The inlet temperature of the fluidizing gas is 105° C. The exhaust gas temperature is 59° C. The classifying gas fed is also nitrogen at a rate of 14 kg/h at a temperature of 30° C. The contents of the fluidized bed are approximately 700 g. The agglomeration output is approximately 1.25 kg per hour. Free-flowing granules are obtained having a mean particle diameter of 0.7 mm. The granules are round and have a rough surface.

In the same apparatus, the previously produced granules were coated with methyl cellulose (aqueous solution containing 2.0% by weight of solid) Methocel A 15 LV (Dow Chemical); 480 g were introduced in advance as a bed. By increasing the classifying gas rate to 20 kg/h at 30° C., no material is discharged, that is to say coating takes place batchwise. The solution is sprayed into the fluidized-bed agglomerator at a temperature of 22° C. The temperature of the atomizing gas is 30° C. To fluidize the bed contents, nitrogen is blown in at a rate of 120 kg/h. The inlet temperature of the fluidizing gas is 140° C. The exhaust gas temperature is 81° C. Free-flowing granules are obtained. The solid particles are round. SEM images of the fracture surfaces show a very uniform and thin coating of the granules (5% by weight of methyl cellulose based on the weight of the granules.

### Use of the Granules in the Application

The flavouring granules and perfume granules mentioned in the examples are used in the foods to be flavoured (for example instant drink powders, teabags for infusion, hard and soft caramels, wine gums, bakery products, dietary preparations, compressed products, chewing gums, ice creams, ice cream coating, filled chocolate products, instant soups and instant sauces, frozen ready meals, heat-treated drinks, soups and sauces, oral hygiene products such as dental cleaning tablets and toothpastes) or are used in the cosmetics products, hygiene products, pharmaceutical products, soap products, detergent products or household products to be perfumed.

### Use Examples

### EXAMPLE 8

### Hard and Soft Caramels

Blue-dyed flavouring granules having encapsulated mint flavouring are mixed at 1% into the hot (140° C.) hard caramel mass consisting of sucrose, glucose syrup and water. The still-hot mass is then poured into moulds.

To produce soft caramels, the flavouring granules are correspondingly incorporated at 120° C. into a mass which comprises sucrose, water, glucose syrup, fat, fondant, gelatin, citric acid and an emulsifier. The mass is then cooled on a cold table to below 40° C. and aerated manually by rolling.

### Advantages

By means of the noticeable particles, an optical effect can be achieved which is retained during processing and storage.

Low flavouring losses occur during processing.

The flavouring is present in the matrix localized at a few places and does not migrate. As a result a particular sensory effect is achieved (hot spots). A different liquid flavouring can be added to the caramel matrix itself as a result of which a sensory double effect can be achieved.

The sucking behaviour of the hard caramels remains unchanged, the particles are not perceived as interfering.

### EXAMPLE 9

### Jellied Fruits

Red-dyed flavouring granules having encapsulated strawberry flavouring which were additionally provided with a fat coating are incorporated at 70° C. into the mass for jellied fruits consisting of water, sucrose, glucose syrup and agar. The mass is then poured into moulding powder.

### Advantages

As a result of the noticeable particles an optical effect can be achieved which is retained in the matrix during processing and storage, despite the relatively high water content.

Low flavouring losses occur during processing.

The aroma is present in the matrix localized at a few places and does not migrate. As a result a particular sensory effect is achieved (hot spots). A different liquid aroma can be added to the matrix itself, as a result of which a sensory double effect can be achieved.

### EXAMPLE 10

### Hard Biscuits

Orange-dyed flavouring granules having encapsulated cheese aroma which was subsequently provided with a fat coating are incorporated into the dough for hard biscuits.

### Advantages

Low flavouring losses occur during the baking process.

The flavouring is present in the matrix localized at a few places and does not migrate, as a result of which a particular sensory effect is achieved (hot spots). A different liquid aroma can be added into the matrix itself, as a result of which a sensory double effect can be achieved.

### EXAMPLE 11

### Chewing Gum

Flavouring granules having encapsulated mint aroma are incorporated into chewing gum mass.

### Advantages

High flavour impact due to partial localization of high flavouring concentrations in the product. The release of the flavouring takes place mechanically during chewing.

### EXAMPLE 12

### Ice Cream

Orange-dyed flavouring granules having encapsulated apricot flavouring, which additionally comprise a fat coating, are incorporated into ice cream.

### Advantages

By means of the noticeable particles an optical effect can be achieved which is retained during storage of the ice cream even under temperature fluctuations.

An additional crispness effect can be achieved even in ice cream as food having a relatively high water activity.

### EXAMPLE 13

### Compressed Products

Flavouring granules which contain encapsulated blueberry flavouring coated with a 5% layer of methyl cellulose are added at 2% to a powder mixture of sorbitol, citric acid and aspartame and compressed on a tableting machine to form compressed products.

### Advantages

The hygroscopicity of the powder mixture is markedly decreased. Sticking to the dye surfaces during compression no longer occurs.

### EXAMPLE 14

### Comparison of the Processes

The figure shows a comparison of the different retention rates (Y axis: retention in %) of individual flavouring components from a strawberry flavouring as a function of the flavouring technique used. The vertical bars each represent the individual flavouring components arranged from left to right in order of decreasing volatility.

It may clearly be seen that in particular for the very volatile components (in each case the bars on the very left of each grouping) the retention for the inventive continuous fluidized-bed agglomeration 5 is very good. This means that the ratios of the flavouring components to one another remain virtually unchanged. The flavour profile thus substantially corresponds to that of the liquid unencapsulated flavouring.

The other techniques shown (1=absorption; 2=spray-drying; 3=agglomeration; 4=compacting) are markedly inferior to continuous fluidized-bed spray agglomeration with respect to flavour profile retention. Retention of the aroma overall is also the highest in the case of the continuous fluidized-bed spray agglomeration.

1. Encapsulated flavouring preparations and/or perfume preparations by means of fluidized-bed spray agglomeration in which a flavouring preparation and/or perfume preparation is sprayed into a fluidized bed having granulation nuclei and in which the mean residence time of the flavouring preparation and/or perfume preparation sprayed in is less than 20 minutes in the fluidized bed.

2. Process for producing encapsulated flavouring preparations and/or perfume preparations, produced by fluidized-bed spray agglomeration, in which a flavouring preparation and/or perfume preparation is sprayed into a fluidized bed having granulation nuclei, characterized in that the mean residence time of the flavouring preparation and/or perfume preparation sprayed in is less than 20 minutes in the fluidized bed.

3. Process according to claim 2, characterized in that the process is carried out continuously.

4. Process according to one of claims 2 or 3, characterized in that the granulation nuclei are produced in a fluidized bed.

5. Process according to one of claims 2 to 4, characterized in that the fluidized bed has a bed height of less than 10 cm.

6. Process according to one of claims 2 to 5, characterized in that granules of the desired particle size are separated by a sifter from the fluidized bed.

7. Process according to one of claims 2 to 6, characterized in that the granules, after their production, are provided with an external coat by spraying on a liquid coating material.

8. Process according to one of claims 2 to 7, characterized in that the flavourings and/or perfumes are used in the form of an emulsion produced by mixing the flavourings and/or perfumes with water and a polymeric carrier.

9. Process according to one of claims 2 to 9, characterized in that the polymeric carriers used are hydrolysed or modified starches and the hydrocolloids used are gum arabic, or mixtures thereof.

10. Process according to one of claims 2 to 9, characterized in that the flavouring emulsion and/or perfume emulsion comprises as additives food dyes or cosmetics dyes, sweeteners, antioxidants, edible acids, flavour-enhancing substances, vitamins, minerals and/or juice concentrates.

11. Use of encapsulated flavouring and/or in foods.

12. Process according to one of claims 4 to 11, characterized in that the flavouring emulsion and/or perfume emulsion also comprises additives and ingredients such as food dyes or cosmetics dyes, sweeteners, sugar substitutes, antioxidants, edible acids, flavour-enhancing substances, vitamins, minerals and/or juice concentrates.
